(19) United States
(12) Patent Application Publication
(10) Pub. No.: US 2014/0269666 A1
(43) Pub. Date: Sep. 18, 2014

(54) METHOD AND APPARATUS FOR EFFICIENT SIGNALING OF COMMUNICATION MODE AND DELIMITER INFORMATION

(71) Applicant: QUALCOMM Incorporated, (US)

(72) Inventors: Gene Wesley Marsh, Encinitas, CA (US); Arumugam Chendamarai Kannan, San Diego, CA (US)

(73) Assignee: QUALCOMM Incorporated, San Diego, CA (US)

(21) Appl. No.: 13/831,715

(22) Filed: Mar. 15, 2013

(51) Int. Cl. H04J 3/06

(52) U.S. Cl. CPC H04J 3/06
USPC 370/350

(57) ABSTRACT

Various aspects for efficient preamble selection and configuration based on wireless communication parameters to provide a reduction of preamble overhead by generating and transmitting packet preambles based on a data rate that is to be used for communication between wireless devices are disclosed herein. In one aspect of the disclosed approach, a preamble sequence is selected from a set of preamble sequences, wherein each preamble sequence is associated with at least one communication mode and the selected preamble sequence is configured to signal a respective communication mode. A preamble structure is generated based on the selected preamble sequences and then transmitted to a receiver. A period of silence may be associated with the communication mode to be communicated, and the transmitter may be configured to not transmit the preamble structure before the period of silence expires.

### BACKGROUND

1. Field

Aspects of the present disclosure relate generally to wireless communication systems, and more particularly, to a method and apparatus for efficient signaling of communication mode and delimiter information.

2. Background

Wireless communications technology has penetrated nearly every aspect of a person's daily routine. Integrated into almost every conceivable electronic device to facilitate business activities as well as personal uses such as entertainment, medicine, and exercise, wireless systems are widely deployed to provide various types of communication content such as voice, data, video, and so on. One type of wireless system technology, referred to as a wireless personal area network (WPAN), provides a wireless communication network for interconnecting devices locally around an individual person. For example, WPAN technology may serve to interconnect the now ubiquitous cell phone with other electronic and communication devices that many people may encounter at their work place, such as printers, scanners, copiers, “wired” multi-line telephone sets, keyboards, mice, etc.; or during personal activities such as exercising, shopping, or dining, such as exercise machines, cash registers, cycling speedometers/odometers, pedometers, automated menu systems, etc. WPAN technology may even serve a more specialized purpose, such as in health care, where wireless sensors may be placed on or near a patient to allow medical professionals to monitor that patient—whether that patient is actually in a medical care facility such as a hospital or remotely through the use of a cell phone or other wireless communication device carried around by that patient.

Packets may be used between a transmitting device, referred to generally as a transmitter, and a receiving device, referred to generally as a receiver, to communicate data with each other during a communication session. The data to be communicated is included in a packet payload portion of a packet structure that is defined in a communication protocol used for the communication session. Packets may also be used to share various parameters of the communication session, such as those related to reassembly or decoding of packets, in addition to any data that is to be communicated. A portion referred to as a packet header is included before the packet payload in the packet structure for storing the various parameters of the communication session. The packet structure may include another portion, referred to as a packet trailer, or footer, after the packet payload. Thus, the packet header precedes the data payload, which is placed in a main portion of the packet referred to as the packet payload and followed by the packet footer.

Before packets may be decoded properly, certain information needs to be communicated between the transmitter and the receiver. For example, in a communication system that supports multiple data rates, the transmitter may need to communicate a data rate at which packets will be transmitted to the receiver. The data rate information is typically placed in the packet header. For example, a data rate mode field in the packet header may be used to communicate a mode of data transfer associated with a particular data rate. The data rate mode field is typically configured as a sequence of bits having a fixed-length that is sufficient to identify each of the multiple data rates.

The transmitter and the receiver also need to be able to achieve synchronization and establishing a common timing in some communication systems so that packets may be detected and decoded properly. One way these devices may achieve synchronization is through transmission of predefined sets of signals preceding communication of a data payload between the devices. For example, each transmission of a data payload by the transmitter may be preceded by a sequence of alternating 1's and 0's. This sequence, generally referred to as a preamble sequence—or simply a preamble where one or more repetitions of a particular preamble sequence are transmitted, is typically also placed at a beginning portion of the packet structure such as the packet header. By detecting and decoding the packet header, the receiver can synchronize its local clock with that of the transmitter.

In addition to the sequences necessary to communicate the data rate and synchronize timing, another sequence of bits is typically used to signal an end of the preamble. This sequence, referred to as a delimiter, is included at the end of the preamble and configured to be a shared sequence known to both the transmitter and the receiver. Thus, the delimiter may be used to indicate a beginning of the rest of the packet, such as a beginning of the packet payload. Similar to the sequences used for the data rate mode field and the preamble, the sequence used for the delimiter is also of a fixed length.

Current approaches use three mechanisms in the packet header to signal: (1) the data rate being used between the transmitter and the receiver; (2) the timing for synchronizing the transmitter and the receiver; and (3) the delimiter that denotes the end of the preamble. Specifically, three identifiers are included in the packet header to indicate data rate, timing and delimiter information, respectively, where each of these sequences is configured as a different sequence of a fixed length known to the receiver. Utilizing these different mechanisms increase resource use both on and in between the transmitter and receiver. Further, utilizing these different mechanisms proportionally increases packet header overhead for faster data rates than for slower data rates, thus affecting the throughput unequally for different data rate conditions.

For example, a system operable at 8 data rates may use a different identifier for each data rate in a data rate mode field. Assuming that each of these data rate identifiers is 128-bits in length, a memory having a size of at least 1,024 bits will be needed on the transmitter to store the data rate identifiers so that an appropriate sequence may be communicated to the receiver. The receiver will also have to include a memory sized to allow storage of the same data rate identifiers. Further, additional memory will be necessary on both the transmitter and the receiver to store the other identifiers used for communicating the timing and delimiter information.

In order to be able to efficiently support the aforementioned features of the packet header, other approaches are desired.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the disclosed approach provide for simultaneously indicating a data rate of a transmission of a packet as well a start of the packet using variable length sequences in a packet header. This approach addresses redundancy in the packet header by combining two signaling functions in a packet preamble. Thus, any overhead incurred due to transmission of the packet preamble may be reduced. Moreover, the packet preamble overhead is proportional to the data rate being used, thereby allowing for a scalable overhead cost.

In one aspect, the disclosure provides a method for wireless communication including determining an estimate of clock-related offsets between a transmitter and a receiver based on determined clock stability information; generating a packet preamble based on the estimate of clock-related offsets; and transmitting the packet preamble to the receiver.

Another aspect of the disclosure provides an apparatus for wireless communication that includes means for determining an estimate of clock-related offsets between a transmitter and a receiver based on determined clock stability information; means for generating a packet preamble based on the estimate of clock-related offsets; and means for transmitting the packet preamble to the receiver.

Yet another aspect of the disclosure provides a computer program product that includes a computer-readable storage medium having code executable by a processing system for determining an estimate of clock-related offsets between a transmitter and a receiver based on determined clock stability information; generating a packet preamble based on the estimate of clock-related offsets; and transmitting the packet preamble to the receiver.

Still yet another aspect of the disclosure provides an apparatus for wireless communication that includes at least one processor and a memory coupled to the at least one processor. The memory is configured to cause the at least one processor to determine an estimate of clock-related offsets between a transmitter and a receiver based on determined clock stability information; generate a packet preamble based on the estimate of clock-related offsets; and transmit the packet preamble to the receiver.

These and other aspects of the invention will become more fully understood upon a review of the detailed description, which follows.

### BRIEF DESCRIPTION OF THE DRAWINGS

These and other sample aspects of the disclosure will be described in the detailed description that follow, and in the accompanying drawings.

FIG. 1 is a block diagram conceptually illustrating an example of a communication scenario to which various aspects of an approach for packet preamble configuration and detection using variable length pseudo-random sequences may be applied.

FIG. 2 is a block diagram illustrating a packet having a packet header that includes a packet preamble configured as a variable length pseudo-random sequence in accordance with various aspects of the disclosed approach.

FIG. 3 is a flow diagram illustrating a packet preamble configuration process configured to operate in accordance with various aspects of the disclosed approach for packet preamble configuration using variable pseudo-random sequences.

FIG. 4 is a block diagram of a packet preamble configuration system configured in accordance with various aspects of the disclosed approach that may be used with the packet preamble configuration process of FIG. 3.

FIG. 5 is a flow diagram illustrating a packet preamble detection process configured to operate in accordance with various aspects of the disclosed approach for packet preamble detection of variable pseudo-random sequences, such as those generated by the packet preamble configuration process of FIG. 3.

FIG. 6 is a block diagram of a packet preamble detection system configured in accordance with various aspects of the disclosed approach that may be used with the packet preamble detection process of FIG. 5.

FIG. 7 is a diagram illustrating various configurations of packet transmissions for packets having a packet header that includes a header preamble configured as a variable length pseudo-random sequence in accordance with various aspects of the disclosed approach.

FIG. 8 is another diagram illustrating various configurations of packet transmissions for packets having a packet header that includes a header preamble selected from a group of header preambles configured as a variable length pseudo-random sequence in accordance with various aspects of the disclosed approach.

FIG. 9 is a block diagram of a random number generator that may be used to generate preamble sequences for header preamble configuration in accordance with various aspects of the disclosed approach that may be used with the header preamble configuration process of FIG. 3.

FIG. 10 is a block diagram illustrating an example of a hardware implementation for an apparatus employing a processing system configured in accordance with various aspects of the header preamble configuration approach described herein.

FIG. 11 is a flow diagram illustrating a wireless communication process configured to use header preambles that are dynamically configured in accordance with various aspects of the disclosed header preamble configuration approach.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the disclosed approach for efficient preamble selection and configuration based on wireless communication parameters provide a reduction of preamble overhead by generating and transmitting packet preambles based on a data rate that is to be used for communication between wireless devices, or nodes, of a wireless communication system. For example, a pair of wireless devices including a transmitter and a receiver may share a protocol using which they may transmit/receive a given packet using one of several different data rates depending on a signal-to-noise ratio (SNR). As SNR is affected by distance, a range for which each data rate may be supported at a respective SNR may be determined. This range may be communicated by the transmitter to the receiver as a “range mode.” In such a scenario, in one aspect of the disclosed approach a preamble sequence configured as described herein that is known to both the transmitter and the receiver may allow for both detection by the receiver of the preamble and communication of a range mode associated with a data rate that is used by the transmitter.

In one aspect of the disclosed approach, on the transmitter side, a transmitted preamble may be selected from an N number of different variable length sequences, where each variable length sequence represents a different range mode. The variable length sequences may be of an M-ary configuration where, for example, M=2 for a variable length sequence using binary (0 or 1) symbols. Further, preferably a first number n-bits of one sequence has a very low cross-correlation with a first n bits of any other sequence. The proposed approach allows for sequences to be of different lengths. Thus, for example, shorter sequences may be used for communication modes that occur over shorter distances.

In another aspect of the disclosed approach, the receiver may check for the presence of any one of the N number of possible preambles. When one of the preambles is detected successfully, then the receiver will be able to determine: (1) the range mode that is being used; and (2) the end of the preamble portion or of the packet header/beginning of data transmission. The receiver and the transmitter may also use the preamble to synchronize their timing. The variable length sequence used in the preamble should have favorable cross-correlation characteristics for partial overlap with other sequences that may be transmitted to allow the receiver to distinguish the sequence uniquely and minimize false detection. Thus, preambles may be selected from sequences having good correlation properties, which may include small cross-correlation properties with other sequences (including shifted versions of themselves), large autocorrelation properties (i.e., a peak at a lag of zero time-shift when the same sequence is compared with itself), or both small cross-correlation and large autocorrelation properties. Typically, sequences are considered to have good correlation properties when there is very little correlation between different sequences as they are shifted against each other, such as from a complex inner product of one sequence with a shifted version of another sequence. Or, in other words, desirable sequences exhibit low cross-correlation, which is a measure of similarity of two waveforms as a function of a time-lag applied to one of them, such that two sequences that have desirable correlation properties will have very low measure of similarity when one of the sequences is compared to the other one of the sequences across any time-shifted versions of the two. Various approaches known by those in the art may be used to configure sequences having a particular emphasis on one or more of these properties.

In yet another aspect of the disclosed approach, the transmitter and the receiver may further save on preamble overhead when a rough timing has been established between the transmitter and the receiver. For example, where timing between the transmitter and receiver has previously been acquired through a synchronization process, the receiver may have a rough estimate of symbol boundaries for detecting and receiving further transmissions from the transmitter. Thus, the transmitter may not need to transmit repetitions of timing signals in order for the receiver to synchronize timing prior to the receiver acquiring the preamble. Further, because the receiver may have a rough timing estimate, the transmitter and receiver may utilize predetermined periods of silence to further reduce preamble acquisition overhead by reducing a search universe of preambles, as described herein.

FIG. 1 illustrates sample aspects of a communications scenario 100 where a transmitter such as a first wireless device 120 may communicate with a receiver such as a second wireless device 140. As a part of establishing communication with the second wireless device 140 in accordance with various aspects of the disclosed approach the first wireless device 120 may first generate and then transmit a preamble signal configured to inform the second wireless device 140 of a particular data rate to be used in the communication between them. In addition, the preamble signal may also be configured to operate as a delimiter to allow the second wireless device 140 to determine when the preamble signal ends. The preamble signal may be embodied in a packet header that includes a variable length preamble, which may be referred to simply as “preamble sequence” herein.

A packet architecture 200 configured in accordance with various aspects of the disclosed approach that may be used in the communications scenario 100 of FIG. 1 is illustrated in FIG. 2. The packet architecture 200 includes a packet header portion 210, a packet payload portion 220, and a packet footer portion 230. The packet header portion 210 may contain a variable length preamble, or simply, preamble sequence 214 configured in accordance with various aspects of the disclosed approach to function as a range mode indicator as well as a delimiter to signal an end of the packet header portion 210 and beginning of the packet payload portion 220. In one aspect of the disclosed approach, the preamble sequence 214 may be stored in the packet header portion 210 after a set of preamble blocks 212-1 to 212-n. Use of the set of preamble blocks 212-1 to 212-n, which may be optional, allows the first wireless device 120 and the second wireless device 140 to perform certain operations such as synchronize timing. As further described herein, preamble blocks 212-1 to 212-n may be used to synchronize timing between a transmitter such as the first wireless device 120 and a receiver such as the second wireless device 140. Once this timing has been established, a preamble sequence configured in accordance with various aspects of the disclosed approach such as the preamble sequence 214 described herein may be used to reduce preamble overhead.

A particular preamble sequence may be configured by the first wireless device 120 using a preamble configuration module 122 and communicated via a wireless transceiver 126 of the first wireless device 120 to a wireless transceiver 142 of the second wireless device 140. In accordance with various aspects of the disclosed approach, the preamble configuration module 122 may customize the preamble sequence based on a combination of a delimiter and a data rate at which packets may be transmitted from the first wireless device 120 to the second wireless device 140. This information (the delimiter and the data rate) may be determined by the second wireless device 140 using a preamble detector 144. In other words, the preamble sequence may be configured to allow detection of an end of the preamble sequence by the preamble detector 144—thereby eliminating use of a specialized packet header delimiter—while simultaneously allowing communication of data rate information by the first wireless device 120 and detection thereof by the preamble detector 144.

In one aspect of the disclosed approach, the preamble sequence may be configured to express the data rate information as a range mode determined by a range determination module 124 of the first wireless device 120. The range mode may be based on an SNR value received from an SNR module 128 that is coupled to the wireless transceiver 126. For example, in one aspect of the disclosed approach, an SNR criterion may be used to select a data rate at which data may be transmitted from the first wireless device 120 to the second wireless device 140. An SNR module 148 of the second wireless device 140 may be used to perform or assist in SNR determination along with the SNR module 128 of the first wireless device 120. In another aspect of the disclosed approach, a data rate may be selected based on other criteria. Once the data rate has been determined, the first wireless device 120 may determine an associated range mode and configure an appropriate preamble sequence.

In configuring a particular preamble sequence with an integrated delimiter to communicate an associated range mode, the first wireless device 120 may customize the preamble sequence to reduce preamble overhead. In accordance with various aspects of the disclosed approach, the preamble sequence may be configured based on a length criterion such that a shorter length variable length sequence may be used for a higher expected data rate. The preamble sequence may also be configured based on a length criterion such that a shorter length variable length sequence may be used for a shorter expected range mode.

In addition to communicating with the second wireless device 140, the first wireless device 120 may also have to communicate with other wireless devices, an example of which is illustrated in FIG. 1 as a third wireless device 160 having a wireless transceiver 162. In one aspect of the disclosed approach, the first wireless device 120 may use the preamble configuration module 122 to utilize another preamble and integrated delimiter for communicating another range mode selected by the range determination module 124 to a preamble detector 164 of the third wireless device 160 in a manner similar to the various aspects of the disclosed approach for the second wireless device 140. Accordingly, each of the second wireless device 140 and the third wireless device 160 may acquire a respective preamble signal transmitted from the first wireless device 120, as separated from a packet payload portion such as the packet payload portion 220 by an integrated delimiter, to determine a data rate at which the data payload is to be communicated from the first wireless device 120. In one aspect of the disclosed approach, the first wireless device 120 may communicate with each of the second wireless device 140 and the third wireless device 160 using a separate range mode and integrated delimiter. In general, the first wireless device 120 may communicate with multiple wireless devices, where the first wireless device 120 may use a different preamble sequence for each wireless device. Each of these different preamble sequences may be configured differently to allow customization of the communication parameters for each pair of wireless devices. For example, the first wireless device 120 may communicate with the second wireless device 140 using a data rate lower than the one at which it communicates with the third wireless device 160 because a lower SNR is experienced between the first wireless device 120 and the second wireless device 140 reports a lower SNR. Thus, the first wireless device 120 may use a longer preamble sequence for the second wireless device 140 than that used for the third wireless device 160 because, as stated herein, a long preamble sequence may allow communication between the first wireless device 120 and the second wireless device 140 to be more robust in view of the lower SNR.

In one aspect of the disclosed approach, to acquire a preamble signal sent from the first wireless device 120, the second and third wireless devices 140 and 160 may respectively use preamble detectors 144 and 164 that may detect preamble sequences. As discussed, these preamble sequences may be of variable lengths having an end as signaled by a delimiter. A determination of the end of the preamble sequence allows the preamble detectors 144 and 164 to recover range mode information contained in the respective preamble sequences. The second and third wireless devices 140 and 160 also respectively include data sinks 146 and 166 to receive information such as the packet payload portion 220 at a data rate based on the recovered range mode information once a communication channel has been established with the first wireless device 120. Further, although not shown herein to avoid unnecessarily complicating the description of various aspects of the disclosed approach, each of the second and third wireless devices 140 and 160 may also include preamble configuration modules that may be used to dynamically generate preambles to communicate with the first wireless device 120, each other, and other wireless devices.

The elements illustrated in the communication scenario 100 may be implemented in different ways in different applications. For example, the wireless transceivers 122, 142, 162 may be configured as a transceiver such as an ultra-wideband (UWB)-capable transceiver. Also, the various aspects of the approach described herein may be implemented in a system where components are attached to one another (e.g., where components are interconnected by wires) or in a system where components are detached from one another (e.g., a wireless system) in various configurations. For example, it should be noted that although the SNR module 128 of the first wireless device 120 is illustrated as being coupled to the range determination module 124 and the wireless transceiver 126, and the SNR module 148 of the second wireless device 140 is coupled to the wireless transceiver 142 and the sequence and range mode detector module 144, the specific configuration and coupling of any SNR modules disclosed herein may be determined by a particular application. Thus, as illustrated, the wireless device 160 may optionally include an SNR module 168.

Various well-known methods and elements may be implemented for communicating between the first wireless device 120 and the second and third wireless devices 140 and 160, and unless otherwise noted, no further description will be provided herein as to these methods and elements so as to allow the various aspects of the disclosed approach to be more thoroughly discussed. Although the communication mode described herein uses a range mode as an example, other communication modes may be communicated using the various aspects of the approach described herein. Also, the various aspects of the approach described herein may be employed in conjunction with processing of various types of information. For example, in some implementations this information may comprise control information that may be used to control certain operations at different components. In some implementations this information may comprise data such as audio data, video data, sensor data, or gaming data.

FIG. 3 illustrates a variable length preamble configuration process 300 configured to generate preamble sequences of various lengths that include associated range mode and integrated delimiter information. The variable length preamble configuration process 300 may be implemented in a variable length preamble packet header configuration system 400 as shown in FIG. 4 that includes a packet header configuration module 410 and a range determination module 430 implemented in accordance with various aspects of the disclosed approach. The variable length preamble packet header configuration system 400 may be implemented in a transmitter such as the first wireless device of 120 of FIG. 1 as the preamble configuration module 122, and configure preamble sequences for transmission to a receiver such as the second wireless device 140 of FIG. 1. The preamble sequences may be generated using pseudo-random sequences, as described below, and be included as a packet preamble such as the variable length preamble sequence 214 in the packet header portion 210 of the packet architecture 200.

After selection of the preamble sequence, a packet header containing the preamble sequence for range mode Y may be created by a packet header generation module 420. During the creation of the packet header, the packet header generation module 420 may configure a period of silence before the transmission of the preamble sequence for range mode Y, where the period of silence is determined by a quiescence period configuration module 418. As further described herein, the quiescence period configuration module 418 may optionally be used to introduce a period of silence in the transmission of the packet header. The period of silence may be used by the transmitter in assisting to reduce a universe of preamble sequences that needs to be searched by the receiver.

At 302, the transmitter acquires a common seed for generating pseudorandom numbers for use in a pseudorandom sequence generator such as one that may be contained in the VLPS generation module 412. The common seed uniquely determines an initial state of the pseudorandom sequence generator. In one aspect of the disclosed approach, both the transmitter and the receiver use the common seed as a shared key to be able to generate the same pseudorandom sequence on each device. For example, each of the first wireless device 120 and the second wireless device 140 may include a pseudorandom sequence generator such as the VLPS generation module 412. The pseudorandom sequence generator may be a linear feedback shift register, an example of which is illustrated and further described herein with reference to FIG. 9.

The range determination module 430 may determine the range mode that may be used to select a sequence generated by a variable length preamble sequence (VLPS) generation module 412 in the packet header configuration module 410, with selection being performed by a VLPS selection module 416. Thus, the range mode may be based on an SNR input received from an SNR module such as a SNR module 128 of FIG. 1. In one aspect of the disclosed approach, for an open-loop SNR determination configuration, each device may use an SNR input value based on an SNR determined for a signal communicated between them. For example, the SNR module 128 of the first wireless device 120 may determine an SNR value associated with a communication from the second wireless device 140 based on the SNR module 128 examining a signal transmitted by the second wireless device 140 and received from the first wireless device 120. Similarly, the SNR module 148 of the second wireless device 140 may determine an SNR value associated with a communication from the first wireless device 120 based on a signal transmitted by the first wireless device 120 and received by the second wireless device 140. Further, each of the first device 120 and the second device 140 may report their respectively determined SNR to each other in a closed-loop SNR determination configuration. Thus, the SNR module 148 of the second wireless device 140 may report the SNR value it determined for the signal received from the first wireless device 120 and report that back to the first wireless device 120. The SNR module 128 of the first wireless device 120 may similarly report the SNR value it determined for the signal received from the second wireless device 140 and report that back to the second wireless device 140.

In one aspect of the disclosed approach, the specific preamble sequence lengths used to communicate each range mode may correspond to an SNR required for each data rate to operate successfully at the particular range. For example, if K represents a preamble sequence length, then the preamble lengths required for the N range modes may be defined as K₁, K₂, . . . , K_{N}, where Kᵢ represents a length of a sequence associated with an i-th range mode and i=1 to N (i.e., {i|iε1 . . . N}). Any generated preamble sequences may optionally be stored in a VLPS storage module 414, as further described herein. In other aspects of the disclosed approach, instead of a range mode, one or more criteria may also be used to select a preamble sequence by the VLPS selection module 416. An example of possible range mode and symbol sequence lengths is illustrated in Table 1, below.

TABLE 1
Range Mode Configuration

| Range Mode | Symbol Address Range | Length (Kᵢ) |
|---|---|---|
| 0 | 0:31 | 32 |
| 1 | 0:31 | 32 |
| 2 | 32:95 | 64 |
| 3 | 32:95 | 64 |
| . . . | . . . | . . . |
| N | N_{Start}:N_{End} | K_{N} |

In Table 1, each preamble sequence includes an associated symbol address range [N_{Start}:N_{End}] such that Nₛₜₐᵣₜ corresponds to a start of the preamble sequence with reference to a predetermined start period and N_{End} corresponds to an end of the preamble sequence that corresponds to a length K₁.

At 304, the sequence generation process is initialized. In one aspect of the disclosed approach, the packet header configuration module 410 may be initialized with the common seed and a counter i=1. The VLPS selection module 416 in the packet header configuration module 410 may also be provided with a value Y for a desired range mode, where Y is one of the possible N range modes. As further discussed herein, the sequence generation process may involve several iterations of an algorithmic loop for sequence generation, where the VLPS generation module 412 generates a sequence during each loop and the VLPS selection module 416 determines if the generated sequence is the desired sequence for range mode Y.

At 306, the VLPS generation module 412 may generate an i-th sequence, where the sequence is composed of a number of symbols equal to a sequence length associated with the i-th range mode where, as discussed in the current example, Kᵢ represents a length of a preamble sequence to be generated associated with loop i. For example, if a range mode 1 is to be used, then the VLPS generation module 412 may extract a sequence of K₁ bits from the random sequence being generated and these sequence of K₁ bits may be used as the preamble sequence. If a range mode 2 is to be used, then the VLPS generation module 412 may ignore the sequence of K₁ bits, and use the next sequence of K₂ bits from the random sequence being generated as the preamble sequence. In general, if a range mode Y is to be used, the VLPS generation module 412 may extract and ignore a sequence of K₁+K₂+ . . . +K_{Y-1} bits from the random sequence being generated and use a sequence of K_{Y} bits as the preamble sequence. It should be noted that in addition to ignoring the sequence of K₁+K₂+ . . . +K_{Y-1} bits, an additional number of bits between each sequence Kᵢ may also be ignored if desired in a particular implementation.

At 308, in one aspect of the disclosed approach, the generated sequences may be stored in the VLPS storage module 414. The sequences stored in the VLPS storage module 414 may be retrieved as desired by the VLPS selection module 416 for use as a selected preamble sequence so that sequences is generated once and regeneration of previously generated sequences may be optional. Inclusion of the VLPS storage module 414 may increase storage resource requirements for implementation of the sequence generation process on a transmitter even as it decreases resource use in generating sequences, and thus may not be desirable. However, as further described herein, inclusion of a VLPS storage module may be desirable on a receiver so that multiple preamble sequences may be retrieved and searched for in a transmission. Further, various aspects of the disclosed approach for using variable length preamble sequences as described herein may not need storage of sequences on the transmitter side.

At 310, the VLPS selection module 416 may determine if i=Y, where Y is the desired range mode. If not, then the sequence just generated at 306 is not one to be used for the desired range mode and operation may continue at 312, where the index i may be incremented in order to continue with a generation of another sequence. Although not illustrated, the VLPS selection module 416 may ensure that i will not be incremented beyond N, which is the last sequence that may be generated by the variable length preamble packet header configuration system 400. In one aspect of the disclosed approach, where the preamble sequence for the desired range mode has not been generated, the preamble sequence just generated at 306 may be ignored. Thus, as the transmitter may only need the sequence associated with the desired range mode, the sequence generator at the transmitter may discard all unwanted sequences. Otherwise, the sequence associated with the desired data rate mode has been generated and the process 300 may continue at 314.

At 314, the packet header generation module 420 may use the generated sequence for range mode Y as a preamble sequence to configure a packet preamble in a packet header for transmission to the receiver. In accordance with various aspects of the disclosed approach, the packet header generation module 420 may be configured to include a period of silence before the packet preamble is transmitted, as determined by the quiescence period configuration module 418. In one aspect of the disclosed approach, an association may be created between each range mode and a particular period of silence to allow a reduction of a universe of possible preamble sequences to be searched by the receiver. In the context of the disclosed approach, a period of silence may be understood as a period of time during which the transmitter does not transmit any preamble sequences.

FIG. 5 illustrates a variable length preamble detection process 500 configured to detect and process preamble sequences of various lengths, such as those generated by the variable length preamble configuration process 300, to retrieve associated range mode and integrated delimiter information therefrom. The variable length preamble detection process 500 may be implemented in a variable length preamble processing system 600 as shown in FIG. 6 that includes a packet header processing module 610 and a range determination module 630 implemented in accordance with various aspects of the disclosed approach. The variable length preamble processing system 600 may be implemented in a receiver such as the second wireless device of 140 of FIG. 1 as the preamble detector 144 to process preamble sequences storing range mode information communicated from a transmitter such as the first wireless device 120 of FIG. 1. As described above with reference to the variable length preamble configuration process 300 the preamble sequences may also include integrated preamble delimiter information. The preamble sequences may be received in the form of a sequence of symbols containing a packet preamble such as the variable length preamble sequence 214 in the packet header portion 210 of the packet architecture 200.

The packet header processing module 610 may include a packet buffer 620 to store the received sequence of symbols while a delimiter of a variable length preamble sequence contained in the received sequence of bits may be located by the VLPS detection module 616. Once the delimiter has been located and the variable length preamble sequence is identified by the VLPS detection module 616, a range mode may then be determined by a range mode determination module 630 based on the identified variable length preamble sequence. As noted above, the range mode may be based on an SNR determined by the first wireless device 120. In other aspects of the disclosed approach, instead of just a range mode, one or more criteria may also be determined based on the identified variable length preamble sequence.

In one aspect of the disclosed approach, as further described herein, the VLPS detection module 616 may use preamble sequences generated by a VLPS generation module 612 to identify the transmitted variable length preamble sequence. These generated preamble sequences may be pre-generated by the VLPS generation module 612 and stored in a VLPS storage module 614, as further described herein. During the receipt of the packet header, a period of silence preceding the transmission of the preamble sequence may have been detected by a quiescence period detection module 618, with the transmitter creating the period of silence. The detected period of silence may be used by the VLPS detection module 616 to reduce a universe of preamble sequences that needs to be searched by the VLPS detection module 616.

In accordance with various aspects of the disclosed approach, when the receiver has received a sequence of symbols from the transmitter, the receiver needs to compare all possible sequences that the transmitter could have transmitted in order to detect which sequence was actually transmitted by the transmitter. Thus, as an initial matter the receiver needs to possess a set of potentially transmitted sequences. In one aspect of the disclosed approach, the receiver may generate these sequences and thus not need to be provided with a pre-configured set of sequences. Thus, at 502, the receiver acquires a common seed for generating pseudorandom numbers for use in a pseudorandom sequence generator such as one that may be contained in the VLPS generation module 612. As discussed above, the common seed uniquely determines an initial state of the pseudorandom sequence generator so that the receiver may be able to generate the same pseudorandom sequence as the transmitter. The receiver may then search for an occurrence of one of the sequences in any transmission from the transmitter. Similar to the configuration of the VLPS generation module 412, the pseudorandom sequence generator contained in the VLPS generation module 612 may be implemented as a linear feedback shift register, an example of which is illustrated and further described herein with reference to FIG. 9.

At 504, the sequence generation process is initialized. In one aspect of the disclosed approach, the packet header configuration module 610 may be initialized with the common seed and a counter i=1. The VLPS selection module 616 in the packet header configuration module 610 may also be provided with a value N representing a total number of preamble sequences that may be used by the transmitter to signal range modes. If K represents a preamble sequence length, then the preamble lengths required for the N range modes may be defined as K₁, K₂, . . . , K_{N}, where Kᵢ represents a length of a sequence associated with an i-th range mode and i=1 to N (i.e., {|i|iε1 . . . N}).

At 506, the VLPS generation module 612 may generate an i-th sequence in loop i, where the sequence is composed of a number of symbols equal to a sequence length associated with the i-th range mode, which in this case is K₁. Since the VLPS generation module 612 knows the common seed, the exact same sequences may be generated for all possible rate modes {i}. In general, the VLPS generation module 612 of the packet header processing module 610 may operate in a manner similar to the operation of the VLPS generation module 412 of the packet header configuration module 410 to generate the sequences that the VLPS detection module 612 will need to detect the sequence transmitted by the transmitter, as further described herein. However, in one aspect of the disclosed approach as further described herein, the VLPS generation module 612 may store all generated sequences instead of simply passing them to the VLPS detection module 616. This is because the VLPS detection module 616 does not know a priori what sequence has been selected by the transmitter and thus needs to simultaneously check for several, if not all, of the N preamble sequences by correlating the received sequence with all possible preamble sequences to identify the correct preamble sequence. Thus, although the variable length preamble configuration process 300 allows for a transmitter to ignore sequences for non-desired range modes, the variable length preamble detection process 500 may need a receiver to store all generated sequences from the set of Kᵢ, where {Kᵢ|iε1 . . . N} because the receiver may need these sequences at the ready to identify the transmitted preamble sequence.

At 508, in one aspect of the disclosed approach the VLPS storage module 614 may store all sequences generated at 506 to provide the VLPS detection module 616 with access to retrieve all preamble sequences that the transmitter may possibly transmit such that the preamble sequences may only need to be generated once. Use of the VLPS storage module 614 may increase storage resource requirements for implementation of the sequence detection process on the receiver, but it provides the VLPS detection module 616 with immediate access to the preamble sequences it may need. As further described herein, inclusion of VLPS storage may be desirable on the receiver so that multiple preamble sequences may be retrieved and searched for in a transmission.

At 510, the VLPS generation module 612 may determine if i=N, where N is the value of the last preamble sequence that may be used by the transmitter. If not, then not all sequences have been generated and operation may continue at 512, where the index i may be incremented so the next sequence may be generated.

At 514, the VLPS detection module 616 may use the generated sequences stored in the VLPS storage module 614 to identify the preamble sequence that the transmitter used to configure the packet preamble in the packet header. For example, the VLPS detection module 616 may use cross-correlation to identify a generated sequence stored in the VLPS storage module 614 that has the highest level of similarity with the preamble sequence received from the transmitter. Thus, one or more of the generated sequences may be retrieved from the VLPS storage module 614 and compared to the received sequence of symbols using cross-correlation. As discussed above, the cross-correlation between any two sequences will provide a measure of similarity between them. In an ideal scenario where the received sequence of symbols matches identically with one of the generated sequences stored in the VLPS storage module 614, the VLPS detection module 616 should detect a large peak at one of the time-shifted comparisons between the two sequences, which will mean that the VLPS detection module 616 will have identified the preamble sequence that was transmitted by the transmitter. In accordance with various aspects of the disclosed approach, the VLPS detection module 616 may detect a delimiter of the preamble sequence so as to be able to detect the specific preamble sequence that has been transmitted. From the determined preamble sequence, the range mode determination module 630 may then retrieve the range mode information provided by the transmitter using the preamble sequence.

In one aspect of the disclosed approach, the quiescence period detection module 618 may be used to detect a period of silence inserted by the transmitter before the packet preamble was transmitted. As further described herein, the VLPS detection module 616 may utilize its knowledge of an association between each range mode and a particular period of silence detected by the quiescence period detection module 618 to allow a reduction of the universe of possible preamble sequences to be searched by the receiver. In the context of the disclosed approach, a period of silence may be understood as a period of time during which the receiver does not receive any preamble sequences directed to the receiver from the transmitter. As further described herein, the quiescence period detection module 618 may utilize an expected time of a reception of a preamble sequence as a starting point to the period of silence to allow a determination of a length of time associated with the period of silence.

In one aspect of the disclosed approach, a length of each period of silence may be proportional to a range associated with each range mode. If the range modes are arranged in order from a lower (shorter distance) range mode to a higher (longer distance) range mode, then a lower range mode may be associated with a shorter period of silence. For example, where a first range mode is associated with a first range, and a second range mode is associated with a second range, the first range mode will be lower than the second range mode if the first range is shorter than the second range. Consequently, the first range mode may be associated with a first period of silence that is shorter than a second period of silence associated with the second range mode. These associations would respectively apply to each preamble sequence as each preamble sequence may be associated with a particular range mode. For example, a first preamble sequence that is used to signal the first range mode may be associated with a period of silence that is shorter than one for a second preamble sequence that is used to signal the second range mode.

As discussed above, a transmitter and a receiver may need to acquire and synchronize timing before communications may begin. In this situation, a preamble configured for that purpose is included at the beginning of each packet that enables the receiver to synchronize time and frequency offsets with the transmitter so that the receiver may decode the rest of the packet correctly. These preambles, which typically include multiple repetitions of a sequence of symbols, may enable preamble detection without need for a start time assumption because these multiple repetitions typically have a cyclic characteristic that allows detection by the receiver regardless of its knowledge of a decode start time. However, these preambles, which must typically be longer in length to allow such detection, consequently require more energy—both for the transmitter to transmit, and for the receiver to remain energized to receive at least one complete repetition of the sequence of symbols. These large preambles contribute to significant overhead. Various aspects of the disclosed the approach provide variable length sequences configured for a receiver such as the second wireless device 140 that may still have at least a rough timing synchronization with a transmitter such as the first wireless device 120 to communicate information such as the range mode and delimiter while avoid using long preamble sequence formats such as the ones used for timing and synchronization acquisition where timing has not been established.

In one aspect of the disclosed approach, the quiescence period detection module 618 may maintain timing of any previously established synchronization where the quiescence period detection module 618 may, for example, use the last successful synchronization event. A variety of synchronization techniques may be used to implement a synchronization event, such as the use of a cyclically repeating preamble as described above, or the transmission of a message with time information. The establishment of timing may benefit the receiver in that the VLPS detection module 616 may more quickly identify received variable length preamble sequences while using fewer resources. For example, if the receiver has fairly accurate timing synchronization, the VLPS detection module 616 may forgo any requirement to identity repetitions of a cyclically configured sequence to determine a start of a sequence. Instead, receiver complexity may be reduced because the VLPS detection module 616 may detect a variable length preamble sequence of the type as configured herein as the preamble may be designed to be quite efficient. In terms of a sequence length required for detection, for example, shorter lengths may be used based on knowledge of timing information.

FIG. 7 illustrates an example of various preamble sequences 702-1 to 702-P that may be transmitted before a message portion by a transmitter such as the first wireless device 120 to a receiver such as the second wireless device 140, where each preamble sequence except for the first preamble sequence 702-1 includes a period of silence 704-1 to 704-(P−1) that precedes each transmission as configured by the quiescence period configuration module 418. In one aspect of the disclosed approach, time periods during which each associated preamble sequence could be transmitted are sequentially ordered. For example, to signal a particular range mode using a sequence such as the preamble sequence 702-3, the transmitter may remain silent for a length of time based on a sum of the time periods (silent period=L₁+L₂) associated with preamble sequences (the sequences 702-1 and 702-2) for all unused range modes preceding the particular range mode to be signaled.

In one aspect of the disclosed approach where each preamble sequence is associated with a period of silence and ordered from shorter to longer, as described above, the VLPS detection module 620 may eliminate a preamble sequence representing a particular range mode from the universe of preamble sequences that it needs to search as each respective period of silence passes. In other words, the VLPS detection module 620 may limit the universe of possible preamble sequences it needs to check because it is aware of when a transmission of any particular preamble sequence signaling an associated range mode should approximately begin based on the each period in which it finds itself waiting for a transmission. Thus, if the VLPS detection module 620 does not detect a transmission of a preamble sequence during an associated period of silence, then the VLPS detection module 620 may assume the respective preamble sequence—and thereby the range mode signaled by that preamble sequence—are not being used. For example, in the illustrated preamble sequences, if the preamble sequence 702-4 is to be transmitted, the transmitter may remain silent for a period that is equal to the sum of lengths L₁, L₂, and L₃. After a period of silence 704-1 equal to the length L₁ as detected by the quiescence period detection module 618, the VLPS detection module 620 may eliminate the preamble sequence 702-1 from its universe of possible preamble sequences from which to search. After another period of silence 704-2 equal to the lengths L₁+L₂, the receiver may also eliminate the preamble sequence 702-2 from its universe of possible preamble sequences from which to search, as further described herein.

In general, the receiver may just search for preamble sequences associated with range modes that are higher than those associated with the length of silence. As previously noted, higher range modes are associated with inversely proportionally lower data rates because the higher range modes are used for transmission over longer distances. The longer distances restrict data rates due to such issues as increased SNR. Although introducing periods of silence may reduce efficiency in that some possible transmission time is left unused, packet overhead introduced by this approach may remain constant relative to total packet overhead over all range modes. More importantly, because the universe of preamble sequences for which the receiver may need to search for a possible match is significantly reduced, the receiver may be configured with a lower amount of resources. For example, the receiver may not need to dedicate as much temporary memory to perform correlation operations of possible preamble sequences because a certain number of them may be excluded from consideration. In accordance with some aspects of the disclosed approach, the VLPS storage module 614 may be used for temporary storage for one or more sequences that may be needed, and once those sequences have been eliminated as possible matches—whether because they did not result in positive correlation results or are eliminated as being impossible matches because nothing was received during the period of time for which these sequences. And as further described herein, the VLPS storage module 614 may be used for temporary storage of groups of preamble sequences.

In various aspects of the disclosed approach, not every one of the possible N preamble sequences needs to be selected by the transmitter for use in transmission. For example, Table 2 illustrates one aspect of the disclosed approach, where groupings of sequences may be used. In general, P groups of sequences are constructed by the VLPS generation module 412 such that group u includes a number Sᵤ of the N preamble sequences generated as described above {Sᵤ|uε1 . . . P}. Thus, the output of the VLPS generation module 412 may be formed into groups, where each group may have a different number of sequences, and each sequence may be of a different length such that Lᵤ represents the maximum length of the longest sequence in group u. The groups of sequences may be stored in the VLPS storage module 414 as they are formed, thereby allowing the sequence to be pre-generated. As illustrated, group u=1 contains S₁=3 sequences, group u=2 contains 8₂=1 sequence, etc.

TABLE 2
Sequence Groupings

| Group (u) | No. of Sequences (Sᵤ) | Sequences | Lᵤ |
|---|---|---|---|
| 1 | S₁ = 3 | aaab baa | 9 |
| | | abba baba | |
| | | baab baba b | |
| 2 | S₂ = 1 | aaba baba ba | 10 |
| 3 | S₃ = 2 | baba babb baba | 13 |
| | | aaaa bbbb aaaa a | |
| 4 | S₄ = 2 | abaa bbab aaba aba | 15 |
| . . . | . . . | . . . | . . . |
| P | S_{P} = 3 | baba aa . . . bb baa | L_{P} |
| | | baab ba . . . ab babb | |

In other aspects of the disclosed approach, one or more sequences in the same group u may be of the same length, but sequences in later groups should be of longer length. Thus, for example, one or more sequences in group u=1 may have a length of L₁=9. However, sequences in group u=2 should be of length L₂=10 or greater.

Once the groups of sequences have been formed, the VLPS selection module 416 may then choose a desired sequence as a preamble sequence to be transmitted. FIG. 8 illustrates a use of the sequences from Table 2 where a particular sequence such as one of a plurality of preamble sequences 802-1 to 802-P may be transmitted as a selected preamble sequence before a message. Each of the plurality of preamble sequences 802-1 to 802-P may be chosen from a group x. In one aspect of the disclosed approach, the transmitter may be configured to remain silent for a respective period of silence 804-1 to 804-(P−1) before transmission of the selected preamble sequence if the selected preamble sequence is from a group u>1. Then, once the selected preamble sequence has been transmitted, the transmitter may immediately follow it with the message. For example, if the transmitter is to send a preamble sequence chosen from the sequences in group u=1, for example, then that preamble sequence 802-1 is transmitted, and the message begins immediately after. To send a preamble sequence from the sequences in group u=2, the transmitter is silent for a period of silence L₁ 804-1, and then begins transmission of the selected preamble sequence 802-2 from group u=2, followed immediately by the message. In general, to send a sequence from group u, the transmitter remains silent for a period of silence equal to a period of L_{Silent}=L₁+L₂+ . . . +L₍ᵤ₋₁₎, then transmits the desired sequence followed immediately by the message. By grouping the sequences, search resources at the receiver may be optimized because the receiver only has to simultaneously search for at most a maximum of Sᵢ sequences. For example, referring again to Table 1, during the first period related to the group u=1, the receiver may only have to search for S₁=3 sequences.

FIG. 9 illustrates a random number generator 900 that may be used in accordance with various aspects of the variable length preamble configuration process 300 described herein. In one aspect of the disclosed approach, the random number generator 900 may be implemented using a linear feedback shift register (LFSR) 902, as illustrated in FIG. 9 as an n-bit LFSR that includes an n-bit register block 920. The LFSR 902 may be used to generate pseudorandom values to be used by the VLPS generation module 412 of FIG. 4 to generate desired preamble sequences in accordance with various aspects of the disclosed approach.

A LFSR is a shift register whose output is a linear function of its previous state and, as illustrated, an output of the LFSR 902 is based on results received from an XOR function, implemented as an XOR gate 910 that receives inputs from the n-bit register block 920 with bits a[1]-a[n]. Because in an LFSR only some bits of the overall shift register value may be used in the XOR function, only a particular subset of the total number of registers in the n-bit register block 920 may be coupled to the XOR gate 910. This subset may be defined, where n=72, by a primitive sequence formula as shown below:

Primitive Sequence=x⁷²+x⁶⁸+x⁶⁵+x⁶³+x⁶²+x⁵⁹+x⁵⁶+x⁵⁵+x⁵²+x⁴⁵+x⁴³+x⁴¹+x⁴⁰+x³⁹+x³⁷+x³⁶+x³⁵+x³¹+x³⁰+x²⁷+x²⁴+x²³+x¹⁸+x¹⁵+x¹³+x¹¹+x¹⁰+x⁸+x⁷+x⁵+x⁴+x³+x²+x¹,

where {xᵢ} may represent a connection to XOR gate 910 of a register at an index i in the n-bit register block 920, and:
iε{1, 2, 3, 4, 5, 7, 8, 10, 11, 13, 15, 18, 23, 24, 27, 30, 31, 35, 36, 37, 39, 40, 41, 43, 45, 52, 55, 56, 59, 62, 63, 65, 68, 72}.

The LFSR 902 may be initialized by using a particular set of values in the n-bit register 920, referred to as a seed and illustrated as being received in a “SEED” input in the figure. In one aspect of the disclosed approach, the seed may be shared between two wireless devices so that each of them may generate the same random values to be used to produce an identical set of variable length preamble sequences. For example, the first wireless device 120 and the second wireless device 140 may share a first seed so that each of them may generate a first set of variable length preamble sequences. The first wireless device 120 and the third wireless device 160 may share a second seed different from the first seed so that each of them may generate a second, different set of variable length preamble sequences. In accordance with various aspects of the disclosed approach, the seeds may be pre-shared and a selection process may be used to minimize or eliminate a duplicate seed being used by wireless devices in a communication scheme, such as the second wireless device 140 and the third wireless device 160 using the same seed for communicating with the first wireless device 120.

A wireless node such as any one of the wireless devices described herein may include various components that perform functions based on signals (e.g., comprising information such as data) that are transmitted by or received at the wireless node (e.g., via a transmitter or receiver). For example, a wireless headset may include a transducer configured to provide an audio output based on the information or provide an audio output that associated with (e.g., based on or used to control transmission of) data that is transmitted in conjunction with a synchronization signal. A wireless watch may include a user interface configured to provide an indication based on the information or provide an indication that associated with (e.g., based on or used to control transmission of) data that is transmitted in conjunction with a synchronization signal. A wireless sensing device may include a sensor configured to sense based on the information (e.g., based on a request included in the information) or configured to provide data that is transmitted in conjunction with a synchronization signal.

A wireless node such as any one of the wireless devices described herein may communicate via one or more wireless communication links that are based on or otherwise support any suitable wireless communication technology. For example, in some aspects of the disclosed approach, a wireless node may associate with a network. In some aspects the network may comprise a personal area network (e.g., supporting a wireless coverage area on the order of 30 meters) or a body area network (e.g., supporting a wireless coverage area on the order of 10 meters) implemented using ultra-wideband technology or some other suitable technology. In some aspects the network may comprise a local area network or a wide area network. A wireless node may support or otherwise use one or more of a variety of wireless communication technologies, protocols, or standards such as, for example, CDMA, TDMA, OFDM, OFDMA, WiMAX, and Wi-Fi. Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

In some aspects, a wireless node such as one of the wireless devices described herein may communicate via an impulse-based wireless communication link. For example, an impulse-based wireless communication link may utilize ultra-wideband pulses that have a relatively short length (e.g., on the order of a few nanoseconds or less) and a relatively wide bandwidth. The ultra-wideband pulses may have a fractional bandwidth on the order of approximately 20% or more and/or have a bandwidth on the order of approximately 500 MHz or more.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), an entertainment device (e.g., a music or video device), a headset (e.g., headphones, an earpiece, etc.), a microphone, a medical sensing device (e.g., a biometric sensor, a heart rate monitor, a pedometer, an EKG device, a smart bandage, etc.), a user I/O device (e.g., a watch, a remote control, a light switch, a keyboard, a mouse, etc.), an environment sensing device (e.g., a tire pressure monitor), a computer, a point-of-sale device, an entertainment device, a hearing aid, a set-top box, or any other suitable device. These devices may have different power and data requirements. In some aspects, the teachings herein may be adapted for use in low power applications (e.g., through the use of an impulse-based signaling scheme and low duty cycle modes) and may support a variety of data rates including relatively high data rates (e.g., through the use of high-bandwidth pulses).

In some aspects, a wireless node such as one of the wireless devices described herein may comprise an access device (e.g., an access point) for a communication system. Such an access device may provide, for example, connectivity to another network (e.g., a wide area network such as the Internet or a cellular network) via a wired or wireless communication link. Accordingly, the access device may enable another device (e.g., a wireless station) to access the other network or some other functionality. In addition, it should be appreciated that one or both of the devices may be portable or, in some cases, relatively non-portable. Also, it should be appreciated that a wireless node also may be capable of transmitting and/or receiving information in a non-wireless manner (e.g., via a wired connection) via an appropriate communication interface.

FIG. 10 is a conceptual diagram illustrating an example of a hardware implementation for an apparatus 1000 employing a processing system 1010 that may be used in accordance with various aspects of the disclosed approach for configuring variable length preamble sequences that may simultaneously signal a communication mode as well as integrate a delimiter signaling a beginning of the packet payload. Thus, in accordance with various aspects of the disclosure, an element, or any portion of an element, or any combination of elements for configuration of a packet preamble and use thereof in a communication protocol, including a wireless node, may be implemented with the processing system 1010.

The processing system 1010 includes a packet preamble configuration module 1030 and a packet preamble detection module 1032 that may be configured in accordance with various aspects of the disclosed approach to generate, store, and/or use variable length packet preambles in combination with other elements in the processing system 1010. For example, the processing system 1010 includes one or more processors illustrated as a processor 1014. Examples of processors that may be used to implement processor 1014 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor 1014 may be used by the packet preamble configuration module 1030 to perform such functions as random number generation in a manner as described for the LFSR 902, as illustrated in FIG. 9. The processor 1014 may be used by the packet preamble configuration module 1030 to create variable length preamble sequences in a manner as described for the VLPS generation module 412, as illustrated in FIG. 4. Further, the processor 1014 may be used by the packet preamble configuration module 1030 to select preamble sequences in a manner as described for the VLPS selection module 416. Further still, the processor 1014 may be used by the packet preamble configuration module 1030 to configure a header portion of a packet in a manner as described for the packet header generation module 420 and insert a period of silence before the transmission thereof by the quiescence period configuration module 418.

The processor 1014 may also be used by the packet preamble detection module 1032 to perform such functions as random number generation in a manner as described for the LFSR 902, as illustrated in FIG. 9. The processor 1014 may further be used by the packet preamble detection module 1032 to create variable length preamble sequences in a manner as described for the VLPS generation module 612, as illustrated in FIG. 6. Further still, the processor 1014 may be used by the packet preamble detection module 1032 to detect preamble sequences in a manner as described for the VLPS detection module 616. Further still, the processor 1014 may be used by the packet preamble detection module 1032 to detect a period of silence before the receipt of a preamble sequence by the quiescence period detection module 618.

In this example, the processing system 1010 may be implemented as having a bus architecture, represented generally by a bus 1012. The bus 1012 may include any number of interconnecting buses and bridges depending on the specific application of the processing system 1010 and overall design constraints. The bus 1012 links together various circuits including one or more processors (represented generally by the processor 1014), a memory 1018, and computer-readable media (represented generally by a computer-readable medium 1016). The bus 1012 may also link various other circuits such as timing sources, peripherals, voltage regulators, and power management circuits, which are well known in the art, and therefore, will not be described any further. A bus interface 1020 provides an interface between the bus 1012 and a transceiver 1050. The transceiver 1050 provides a means for communicating with various other apparatus over a transmission medium. Depending upon the nature of the apparatus, a user interface 1040 (e.g., keypad, display, speaker, microphone, joystick) may also be provided.

The processor 1014 is responsible for managing the bus 1012 and general processing, including execution of software that may be stored on the computer-readable medium 1016 or the memory 1018. The software, when executed by the processor 1014, causes the processing system 1010 to perform the various functions described herein for any particular apparatus. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The computer-readable medium 1016 or the memory 1018 may also be used for storing data that is manipulated by the processor 1014 when executing software. For example, this data may include generated variable length preamble sequences and packet preambles as well as any created packet structures. As another example, this data may also include received sequences that need to be examined to identify a transferred packet preamble, which may be the data stored in the packet buffer 620. This data may also include any variables or temporary storage values needed for operation of the processing system 1000, including any temporary storage needed to create the variable length packet preambles and modulation of the packet preambles.

The computer-readable medium 1016 may be a non-transitory computer-readable medium such as a computer-readable storage medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. Although illustrated as residing in the processing system 1010, the computer-readable medium 1016 may reside externally to the processing system 1010, or distributed across multiple entities including the processing system 1010. The computer-readable medium 1016 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one configuration, wireless nodes for wireless communication such as the first device 110, second device 140, and third wireless devices 160 includes means for selecting a preamble sequence from a set of preamble sequences, wherein each preamble sequence is associated with at least one communication mode and the selected preamble sequence is configured to signal a respective communication mode; means for generating a preamble structure based on the selected preamble sequence; and means for transmitting the preamble structure. In one aspect of the disclosed approach, the aforementioned means for selecting a preamble sequence may include the VLPS selection module 416. The preamble sequence may be selected from a set of preamble sequences generated by the VLPS module 412. The means for generating a preamble structure based on the selected preamble sequence may include the packet header generation module 420. The means for transmitting the preamble structure to the receiver may include the transceiver 1050 in the processing system 1010 of FIG. 10. Further, one or more processors in the processing system 1010 may be configured as means for performing the functions recited by the aforementioned means. In yet another aspect, the aforementioned means may be a module or any apparatus configured to perform the functions recited by the aforementioned means.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

As an example of some of the various aspects of the disclosed approach, FIG. 11 illustrates a wireless communication process 1100 that may be configured to use packet preambles that are created using the disclosed approach where, at 1102, a preamble sequence is selected from a set of preamble sequences, wherein each preamble sequence is associated with at least one communication mode and the selected preamble sequence is configured to signal a respective communication mode. In accordance with various aspects of the disclosed approach, the preamble sequence may be chosen from a portion of a pseudo-random sequence of bits generated based on a shared common seed. Multiple segments of the sequence of bits may be organized into groups of sequences, and one segment of one group of the groups of sequences may be chosen as the selected preamble sequence. After the preamble sequence has been selected then, at 1104, a preamble structure may be generated based on the selected preamble sequence. In one aspect of the disclosed approach, the generation of the preamble structure includes determining a timing associated with the one group of the groups of sequences from which the at least one segment is selected, and inserting a delay of the transmission of the preamble sequence based on the timing as part of the preamble structure. Once the packet structure has been generated then, at 1106, the packet structure is transmitted to the receiver.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Also, it should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Unless specifically stated otherwise, the term “some” refers to one or more. A phrase referring to “at least one of” a list of items refers to any combination of those items, including single members. As an example, “at least one of: A, B, or C” is intended to cover: A; B; C; A and B; A and C; B and C; and A, B and C.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication comprising:
selecting a preamble sequence from a set of preamble sequences, wherein each preamble sequence is associated with at least one communication mode and the selected preamble sequence is configured to signal a respective communication mode;
generating a preamble structure based on the selected preamble sequence; and,
transmitting the preamble structure.

2. The method of claim 1, wherein selecting the preamble sequence from the set of preamble sequences comprises:
generating a sequence of bits based on a shared common seed; and
choosing a portion of the sequence of bits as the selected preamble sequence based on the at least one communication mode.

3. The method of claim 2, wherein choosing the portion of the sequence of bits as the selected preamble sequence comprises selecting, from one group of a plurality of groupings of sequences formed from the sequence of bits, at least one segment as the selected preamble sequence based on the at least one communication mode.

4. The method of claim 3, wherein the one grouping of the plurality of groupings of sequences formed from the sequence of bits comprises sequences comprising a shared portion of the sequence of bits.

5. The method of claim 3, further comprising:
determining a timing associated with the one group of the groupings of sequences from which the at least one segment is selected; and
delaying transmission of the preamble sequence based on the timing.

6. The method of claim 5, wherein the timing is based on a longest segment length of the multiple segments of the one group of the groups of sequences.

7. The method of claim 5, wherein the groups of sequences are ordered, and the timing is based on a sum of segment lengths of sequences from any groups of sequences occurring in the order prior to the one group of the groups of sequences.

8. The method of claim 2, wherein the sequence of bits may be divided into a plurality of non-overlapping segments (K₁, K₂, . . . , K_{N}), wherein N represents a total number of supported communication modes, and Kᵢ is a non-overlapping segment associated with an i-th communication mode, wherein i=1 to N, and wherein the selecting the portion of the sequence of bits comprises:
selecting a mode i; and
storing the Kᵢ non-overlapping segment as the portion of the sequence of bits for the selected preamble sequence.

9. The method of claim 2, wherein the sequence of bits is a pseudo-random sequence generated using a seed based on the shared common seed.

10. The method of claim 1, wherein the set of preamble sequences comprises a plurality of bit sequences of different lengths.

11. The method of claim 10, wherein at least one of the plurality of bit sequences comprises a length based on the at least one communication mode.

12. The method of claim 11, wherein the at least one communication mode comprises a range mode, and the length is based on a Signal-to-Noise Ratio (SNR) required for the range mode.

13. The method of claim 11, wherein the at least one communication mode comprises a data rate, and the length is proportional to the data rate.

14. The method of claim 1, wherein a first plurality of bits of each preamble sequence in the set of preamble sequences comprise a low cross-correlation property with other preamble sequences in the set of preamble sequences.

15. An apparatus for wireless communication comprising:
means for selecting a preamble sequence from a set of preamble sequences, wherein each preamble sequence is associated with at least one communication mode and the selected preamble sequence is configured to signal a respective communication mode;
means for generating a preamble structure based on the selected preamble sequence; and,
means for transmitting the preamble structure.

16. The apparatus of claim 15, wherein the means for selecting the preamble sequence from the set of preamble sequences comprises:
means for generating a sequence of bits based on a shared common seed; and
means for choosing a portion of the sequence of bits as the selected preamble sequence based on the at least one communication mode.

17. The apparatus of claim 16, wherein the means for choosing the portion of the sequence of bits as the selected preamble sequence comprises means for selecting, from one group of a plurality of groupings of sequences formed from the sequence of bits, at least one segment as the selected preamble sequence based on the at least one communication mode.

18. The apparatus of claim 17, wherein the one grouping of the plurality of groupings of sequences formed from the sequence of bits comprises sequences comprising a shared portion of the sequence of bits.

19. The apparatus of claim 17, further comprising:
means for determining a timing associated with the one group of the groups of sequences from which the at least one segment is selected; and
means for delaying transmission of the preamble sequence based on the timing.

20. The apparatus of claim 19, wherein the timing is based on a longest segment length of the multiple segments of the one group of the groups of sequences.

21. The apparatus of claim 19, wherein the groups of sequences are ordered, and the timing is based on a sum of segment lengths of sequences from any groups of sequences occurring in the order prior to the one group of the groups of sequences.

22. The apparatus of claim 16, wherein the sequence of bits may be divided into a plurality of non-overlapping segments (K₁, K₂, . . . , K_{N}), wherein N represents a total number of supported communication modes, and Kᵢ is a non-overlapping segment associated with an i-th communication mode, wherein i=1 to N, and wherein the means for selecting the portion of the sequence of bits comprises:
means for selecting a mode i; and
means for storing the Kᵢ non-overlapping segment as the portion of the sequence of bits for the selected preamble sequence.

23. The apparatus of claim 16, wherein the sequence of bits is a pseudo-random sequence generated using a seed based on the shared common seed.

24. The apparatus of claim 15, wherein the set of preamble sequences comprises a plurality of bit sequences of different lengths.

25. The apparatus of claim 24, wherein at least one of the plurality of bit sequences comprises a length based on the at least one communication mode.

26. The apparatus of claim 25, wherein the at least one communication mode comprises a range mode, and the length is based on a Signal-to-Noise Ratio (SNR) required for the range mode.

27. The apparatus of claim 25, wherein the at least one communication mode comprises a data rate, and the length is proportional to the data rate.

28. The apparatus of claim 15, wherein a first plurality of bits of each preamble sequence in the set of preamble sequence comprise a low cross-correlation property with other preamble sequences in the set of preamble sequence.

29. A computer program product comprising:
a computer-readable storage medium comprising code executable by a processing system for:
selecting a preamble sequence from a set of preamble sequences, wherein each preamble sequence is associated with at least one communication mode and the selected preamble sequence is configured to signal a respective communication mode;
generating a preamble structure based on the selected preamble sequence; and,
transmitting the preamble structure.

30. The computer program product of claim 29, wherein the code executable by the processing system for selecting the preamble sequence from the set of preamble sequences comprises code executable by the processing system for:
generating a sequence of bits based on a shared common seed; and
choosing a portion of the sequence of bits as the selected preamble sequence based on the at least one communication mode.

31. The computer program product of claim 30, wherein the code executable by the processing system for choosing the portion of the sequence of bits as the selected preamble sequence comprises code executable by the processing system for selecting, from one group of a plurality of groupings of sequences formed from the sequence of bits, at least one segment as the selected preamble sequence based on the at least one communication mode.

32. The computer program product of claim 31, wherein the one grouping of the plurality of groupings of sequences formed from the sequence of bits comprises sequences comprising a shared portion of the sequence of bits.

33. The computer program product of claim 31, wherein the computer-readable storage medium further comprises code executable by the processing system for:
determining a timing associated with the one group of the groupings of sequences from which the at least one segment is selected; and
delaying transmission of the preamble sequence based on the timing.

34. The computer program product of claim 33, wherein the timing is based on a longest segment length of the multiple segments of the one group of the groups of sequences.

35. The computer program product of claim 33, wherein the groups of sequences are ordered, and the timing is based on a sum of segment lengths of sequences from any groups of sequences occurring in the order prior to the one group of the groups of sequences.

36. The computer program product of claim 30, wherein the sequence of bits may be divided into a plurality of non-overlapping segments (K₁, K₂, . . . , K_{N}), wherein N represents a total number of supported communication modes, and Kᵢ is a non-overlapping segment associated with an i-th communication mode, wherein i=1 to N, and wherein the code executable by the processing system for selecting the portion of the sequence of bits comprises code executable by the processing system for:
selecting a mode i; and
storing the Kᵢ non-overlapping segment as the portion of the sequence of bits for the selected preamble sequence.

37. The computer program product of claim 30, wherein the sequence of bits is a pseudo-random sequence generated using a seed based on the shared common seed.

38. The computer program product of claim 29, wherein the set of preamble sequences comprises a plurality of bit sequences of different lengths.

39. The computer program product of claim 38, wherein at least one of the plurality of bit sequences comprises a length based on the at least one communication mode.

40. The computer program product of claim 39, wherein the at least one communication mode comprises a range mode, and the length is based on a Signal-to-Noise Ratio (SNR) required for the range mode.

41. The computer program product of claim 39, wherein the at least one communication mode comprises a data rate, and the length is proportional to the data rate.

42. The computer program product of claim 29, wherein a first plurality of bits of each preamble sequence in the set of preamble sequences comprise a low cross-correlation property with other preamble sequences in the set of preamble sequences.

43. An apparatus for wireless communication, comprising:
at least one processor; and
a memory coupled to the at least one processor and configured to cause the at least one processor to:
select a preamble sequence from a set of preamble sequences, wherein each preamble sequence is associated with at least one communication mode and the selected preamble sequence is configured to signal a respective communication mode;
generate a preamble structure based on the selected preamble sequence; and,
transmit the preamble structure.

44. The apparatus of claim 43, wherein the memory is further configured to cause the at least one processor to:
generate a sequence of bits based on a shared common seed; and
choose a portion of the sequence of bits as the selected preamble sequence based on the at least one communication mode.

45. The apparatus of claim 44, wherein the memory is further configured to cause the at least one processor to select, from one group of a plurality of groupings of sequences formed from the sequence of bits, at least one segment as the selected preamble sequence based on the at least one communication mode.

46. The apparatus of claim 45, wherein the one grouping of the plurality of groupings of sequences formed from the sequence of bits comprises sequences comprising a shared portion of the sequence of bits.

47. The apparatus of claim 45, wherein the memory is further configured to cause the at least one processor to:
determine a timing associated with the one group of the groupings of sequences from which the at least one segment is selected; and
delay transmission of the preamble sequence based on the timing.

48. The apparatus of claim 47, wherein the timing is based on a longest segment length of the multiple segments of the one group of the groups of sequences.

49. The apparatus of claim 47, wherein the groups of sequences are ordered, and the timing is based on a sum of segment lengths of sequences from any groups of sequences occurring in the order prior to the one group of the groups of sequences.

50. The apparatus of claim 44, wherein the sequence of bits may be divided into a plurality of non-overlapping segments (K₁, K₂, . . . , K_{N}), wherein N represents a total number of supported communication modes, and Kᵢ is a non-overlapping segment associated with an i-th communication mode, wherein i=1 to N, and wherein the memory is further configured to cause the at least one processor to:
select a mode i; and
store the Kᵢ non-overlapping segment as the portion of the sequence of bits for the selected preamble sequence.

51. The apparatus of claim 44, wherein the sequence of bits is a pseudo-random sequence generated using a seed based on the shared common seed.

52. The apparatus of claim 43, wherein the set of preamble sequences comprises a plurality of bit sequences of different lengths.

53. The apparatus of claim 52, wherein at least one of the plurality of bit sequences comprises a length based on the at least one communication mode.

54. The apparatus of claim 53, wherein the at least one communication mode comprises a range mode, and the length is based on a Signal-to-Noise Ratio (SNR) required for the range mode.

55. The apparatus of claim 53, wherein the at least one communication mode comprises a data rate, and the length is proportional to the data rate.

56. The apparatus of claim 43, wherein a first plurality of bits of each preamble sequence in the set of preamble sequences comprise a low cross-correlation property with other preamble sequences in the set of preamble sequences.
